(19) United States
(12) Patent Application Publication
(10) Pub. No.: US 2021/0395509 A1
(43) Pub. Date: Dec. 23, 2021

(54) POLYMER MICROSPHERES OF HIERARCHICALLY STRUCTURED CELLULOSE NANOCRYSTALS AND METHOD TO PRODUCE THE SAME

(71) Applicant: FPInnovations, Pointe-Claire (CA)

(72) Inventors: Wadood Y. HAMAD, Vancouver (CA); Chuanwei MIAO, Richmond (CA)

(21) Appl. No.: 17/292,057

(22) PCT Filed: Sep. 24, 2019
(86) PCT No.: PCT/CA2019/051363

§ 371 Date: May 7, 2021

Related U.S. Application Data
(60) Provisional application No. 62/757,427, filed on Nov. 8, 2018.

(51) Int. Cl. C08L 51/02; C08J 3/12; C08L 1/02; C08L 29/04

(52) U.S. Cl. CPC C08L 51/02; C08J 3/122; C08J 2401/02; C08L 29/04; C08L 2207/53; C08L 1/02

(57) ABSTRACT

It is provided a microspherical structure comprising an external shell of structured cellulose nanocrystals (CNCs) and at least one polymer, and a core, wherein the core can be hollow or filled with an immiscible medium. It is also provided a method for producing the same comprising spray-drying the mixture of CNCs and polymer through an atomizer and into a drying chamber forming droplets, wherein the solvent used to suspend the CNCs is evaporated and the microspherical structures are formed. These microstructural spheres can have wide industrial, medical and pharmaceutical applications, whereby their ingredients and structure are tuned and controlled.

### TECHNICAL FIELD

It is described microspheres whose shells are composed of a thin composite layer of cellulose nanocrystals (CNCs) and polymers, and method to produce same.

### BACKGROUND

Polymer microspheres, or microcapsules, refer to polymeric particles in a wide range of diameters, normally from several tens of nanometers to several hundreds of micrometers.

Methods for producing microspheres have been described including single and double emulsion solvent evaporation, spray drying, phase separation, and interfacial polymerization. Polymeric microspheres have a variety of uses in the medical and industrial areas.

There is expanded interest in developing polymeric biomaterials, notably injectable microspheres for fillers of soft tissue (such as for correcting wrinkles and lips), drug-delivery for controlling release of an active compounds or as a carrier vehicle for recognition molecules (such as antibodies, antigens, or nucleic acid probes).

In industrial sectors, polymer microspheres filled with active molecules such as corrosion inhibitors, self-healing agents, or fragrance oil, for example, have been used to increase coating functionality. Formaldehyde-based binders, melamine formaldehyde (MF) and urea formaldehyde (UF), are example of microspheres used in a variety of industrial applications. Safety and environmental concerns around formaldehyde exposure have created a need for formaldehyde-free polymer microspheres.

It is thus desirable to be provided with polymer microsphere formulations.

### SUMMARY

In accordance to an embodiment, it is provided a microspherical structure comprising an external shell of structured cellulose nanocrystals (CNCs) and at least one polymer; and a solid or hollow core.

In an embodiment, the polymer is a homopolymer or a copolymer.

In a further embodiment, the polymer is polyvinyl alcohol (PVA), polyacrylamide, polyethylene oxide, polyethyleneimines, polyamines, quaternary ammonium polymers, carboxymethylated polymers, polyvinylpyrrolidone and copolymers, polyacrylic acid and copolymers, or a mixture thereof.

In a further embodiment, the CNCs surfaces are functionalized.

In an additional embodiment, the CNCs surfaces are functionalized by pH changing, grafting of a small molecule, or adsorption of a small molecule.

In another embodiment, the CNCs surfaces are grafted with polyvinyl alchohol (PVA), polyethylene oxide, polyethylene glycol, polymethylmethacrylate, polyethylhexylmethacrylate, or other polymers whose monomers have similar water solubility as CNCs.

In a further embodiment, the polymer is attached to the CNCs surfaces covalently.

In another embodiment, the core comprises an immiscible medium.

In another embodiment, the immiscible medium is an oil, a solvent or solution containing functional ingredients.

In an embodiment, the core is hollow.

In another embodiment, the microspherical structure described herein comprises from 0.1 to 10 wt. % of CNCs.

In an embodiment, wherein the CNCs are from wood pulp, cotton, grass, wheat straw or tunicate.

It is also provided a method of producing a microspherical structure as encompassed herein comprising the steps of suspending CNCs in a solvent forming a suspension of CNCs; mixing the suspension of CNCs and a polymer forming a mixture of CNCs and polymer; spraying the mixture of CNCs and polymer through an atomizer and into a drying chamber forming droplets; and evaporating the solvent from the droplets forming the microspherical structure.

In an embodiment, the solvent is water, dimethyl sulfoxide (DMSO), N-methylpyrrolidone (NMP), dimethyl acetamide (DMA), N,N-dimethylformamide (DMF), propylene carbonate, acetonitrile, pyridine, methanol, acetone, 1,4-dioxane, butanone, ethyl acetate, tetrahydrofuran (THF), toluene, or xylene.

In another embodiment, the polymer is first dissolved before being mixed with the suspension of CNCs.

In a further embodiment, the method described herein further comprises adding an immiscible medium to the mixture of CNCs and polymer forming a Pickering emulsion.

In an embodiment, the Pickering emulsion is formed by high shear mixing.

In accordance to an embodiment, the solvent is evaporated by the addition of hot air in the drying chamber at a temperature of 100 to 200° C.

### BRIEF DESCRIPTION OF THE DRAWINGS

Reference will now be made to the accompanying drawings.

FIG. 1 illustrates schematically a process to produce hollow polymer microspheres of hierarchically structured CNCs using spray drying in accordance with an embodiment.

FIG. 2 illustrates schematically a process to produce filled polymer microspheres of hierarchically structured CNCs using spray drying in accordance with an embodiment.

FIG. 3 illustrates schematically the spray drying process and harvest of hollow/filled polymer microspheres in accordance with an embodiment.

FIG. 4 illustrates a SEM image of pure CNC powders showing the plate-like structures when spray dried without polymers.

FIG. 5 illustrates a schematic representation of the hierarchical structure of CNCs in the shell of polymer microspheres when spray dried with polymers.

FIG. 6 illustrates a SEM image of polymer microspheres with hierarchically structured CNCs when spray dried with polymers.

FIG. 7 illustrates SEM images of a carefully fractured hollow polymer microsphere showing the cross section of the shell and the hierarchical structure of CNCs in the wall.

FIG. 8 illustrates an optical microscope image of filled polymer microspheres.

FIG. 9 illustrates a SEM image of a carefully fractured filled polymer microsphere showing the filled content.

### DETAILED DESCRIPTION

There is provided microspheres whose shells are composed of a thin composite layer of cellulose nanocrystals (CNCs) and polymers, and method to produce same.

Cellulose is the major constituent of wood and plant cell walls and is the most abundant biomaterial on the planet. Cellulose is therefore an extremely important resource for the development of sustainable technologies. Cellulose nanocrystals (CNCs) are generally extracted as a colloidal suspension by (typically sulfuric) acid hydrolysis of lignocellulosic materials, such as bacteria, cotton, wood pulp, tunicate and the like. Once extracted, typically CNCs are processed into a suspension or gel, and can be dried to form solid films, cellular structures by freeze or spray drying, or combinations thereof.

CNCs characteristically possess a negative charge on the surface including sulfate half-ester groups (—SO₃H or —SO₃Na), carboxylates (—COOH or —COONa) or phosphates (O—PO₃H₂ or O—PO₃Na₂). In a preferred embodiment, the CNCs possess sulfate half-ester groups (—SO₃H or —SO₃Na). H₂SO₄-catalyzed CNCs have a specifically high dipole moment, ca. 4400±400 D, along the CNC's long axis. CNCs possess a high degree of crystallinity in the bulk material, while various degrees of order, or in other words different levels of amorphicity, may exist on the surface. The colloidal suspensions of CNCs are characterized as liquid crystalline at a critical concentration, ca. 5-7 wt. %, and the chiral nematic organization of CNCs remain unperturbed in films formed upon evaporation. CNCs also have a degree of crystallinity between about 85% and about 97%, more preferably between about 90% and about 97% (that is, approaching the theoretical limit of crystallinity of the cellulose chains), which is the ratio of the crystalline contribution to the sum of crystalline and amorphous contributions as determined from original powder X-ray diffraction patterns. Moreover, CNCs may have a degree of polymerization (DP) of 90<DP<110, and between about 3.7 and about 6.7 sulfate groups per 100 anhydroglucose units (AGU).

It is thus provided polymer microspheres produced by spray drying, and resulting in two types of structures: hollow or core-shell. When an aqueous system containing both CNCs and polymer is spray dried, hollow microspheres are obtained. If the CNCs and polymer are mixed with a second phase to form a Pickering emulsion, spray drying of such materials produces microspheres filled with the second phase in the emulsion. In both cases, the external shell is composed of hierarchically structured cellulose nanocrystals (CNCs) and a polymer. The interior of the microspheres can either be hollow or filled, leading to create hierarchical core-shell microspherical structures.

It is provided a category of polymer microspheres and the method to produce them. The polymer microspheres encompassed herein comprise in an embodiment a hollow structure or core-shell structure. In either case, the microsphere shells are composed of cellulose nanocrystals (CNCs) and polymers. CNC surfaces can be functionalized with specific molecules, such as pH- or temperature-responsive groups, and the polymers can be a homopolymer or a copolymer. The polymers can be dissolved in the medium, in which the CNCs are dispersed, or attached to CNC surfaces via covalent bonds.

To produce said polymer microspheres, the medium containing both CNCs and polymers is processed using a spray dryer. During this process, the concentration of CNCs, the ratio of polymers to CNCs, and the spray drying conditions need to be properly established. Hollow microspheres are obtained using suspension of CNCs and a suitable polymer, whereas core-shell microspheres are obtained if the medium containing CNCs and polymer is mixed with another immiscible medium to form an emulsion via high-shear mixing. The emulsion is then processed by spray drying.

The CNCs could be produced from bleached wood pulp by acid hydrolysis. However, CNCs produced from other biomass, such as, but not limited to, cotton, grass, wheat straw, and tunicate, are also encompassed. The CNCs are used as aqueous suspensions with pristine or polymer grafted surfaces at neutral pH. In an embodiment, CNC surfaces can also be modified by changing pH, grafting of small molecules, adsorption of small molecules, or absorption of polymers.

A medium to disperse CNCs is water for example. Other solvents that can disperse CNCs can also be used, such as for example and no limited to, dimethyl sulfoxide (DMSO), N-methylpyrrolidone (NMP), dimethyl acetamide (DMA), N,N-dimethylformamide (DMF), propylene carbonate, acetonitrile, pyridine, methanol, acetone, 1,4-dioxane, butanone, ethyl acetate, chloroform, tetrahydrofuran (THF), toluene, or xylene. The concentration of CNCs can be adjusted from 0.1 to 10 wt. % as long as the viscosity of the final suspension is not an issue for the atomization during spray drying.

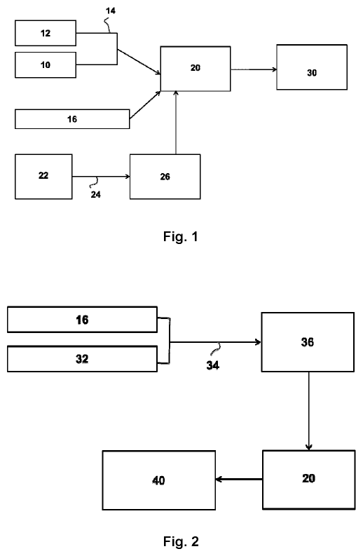

The polymer used in the examples below was polyvinyl alcohol (PVA), but other polymers that are soluble in the medium in which CNCs are dispersed can be used. For example, polyacrylates, polyesters, polyamides, or polysaccharides. The polymer can be a homopolymer or a copolymer. A mixture of two or more polymers can also be used and is encompassed herein. In these examples, the loading of the polymer in the CNC suspension is referred to as the weight ratio of CNCs to polymer. The criteria are that the quantity of the polymer in the spray dried microspheres must be able to form a strong shell structure together with the CNC nanoparticles, and this structure does not collapse during spray drying. Meanwhile, the addition of the polymer should not cause atomization problems due to increased viscosity. As depicted in FIG. 1, the polymer 12 can be dissolved separately in the solvent in which CNCs 10 are dispersed and then mixed together with the CNC suspension 14. The polymer can also be dissolved directly in the CNC suspension 16. In either case, the solvent containing both CNCs and polymers is processed by spray drying 20 to obtain hollow polymer microspheres 30 as described in FIG. 1.

The polymers can also be grafted 26 onto CNC surfaces via in-situ polymerization 24 of the monomer in the presence of CNCs 22 or by reactions between the functional groups on CNC surfaces and polymer chains. This method can also be used to modify CNC surface properties and impart CNC dispersibility in apolar solvents. The polymer grafted-CNCs can be spray dried 20 directly to produce hollow polymer microspheres 30.

As shown in FIG. 2, to produce core-shell microspheres 40 (filled microspheres of hierarchically structured CNCs), CNC-stabilized emulsions 36 need to be formed prior to spray drying 20. CNCs can form a thin layer at the oil droplet 32 surfaces to stabilize oil-in-water Pickering emulsions. Polymers are added in the same phase where CNCs are dispersed in 16, and the quantity of added polymer should not interfere with the formation of Pickering emulsions. The formed emulsions following high shear mixing 34 for example are dried using a spray dryer 20 to obtain filled polymer, or core-shell, microspheres. The filled content in the microspheres is the dispersed phase in the Pickering emulsions. The volume percentage of the dispersed phase can be controlled at a level where the CNC-stabilized droplets are maintained during the spray drying process. In the examples described below, a light mineral oil is used. However, other solvents or polymers that are immiscible with water can be employed. For phases with higher melting temperatures, such as paraffin wax, the emulsification process can be carried out at temperatures above the melting point of the phase. Functional ingredients, such as drugs, pesticides, or inks, can be added in the filled contents.

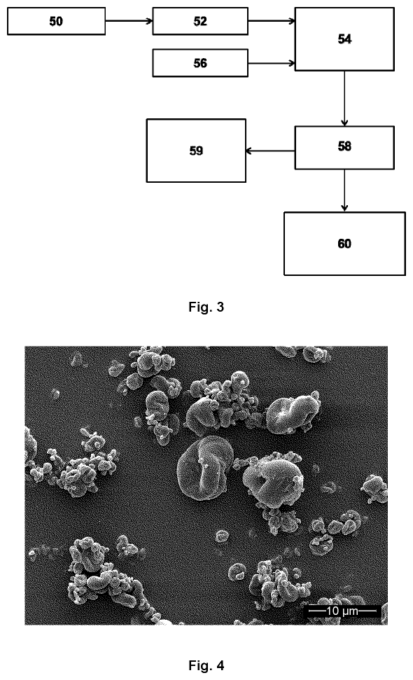

During the spray drying processing, either the solvent containing both CNCs and polymers or the CNC-stabilized Pickering emulsion 50 is fed into an atomizer 52 where the liquid is converted to a mist and spread into a drying chamber 54 (FIG. 3). Hot air 56 at controlled temperature is fed into the drying chamber 54 together with the mist, and the solvent in the mist is evaporated instantly owing to the high temperature of the hot air as well as the large surface area of the droplets in the mist. The dried materials are polymer microspheres 60 (hollow/filled microspheres of hierarchically structured CNCs) and separated from the vapor and air 59 in a cyclone 58. The diameter of the dried microspheres can be controlled by adjusting the atomization method and/or conditions and the concentration of CNC or polymer in the solvent. The microsphere diameter may vary from 1 μm to 100 μm. The microspheres are collected as product and the vapor and air are exhausted. This process is illustrated in FIG. 3. During spray drying 20, efficient atomization is critical for the formation of microspheres, therefore, a proper atomization method and operating conditions are necessary. The inlet hot air temperature should also be controlled carefully and the typical range is 100 to 200° C. The criterion is that the temperature should be as low as possible to reduce energy cost, but high enough for instant drying of the mist. Lower operating temperature is especially preferred when temperature-sensitive ingredients are involved in the suspension to dry.

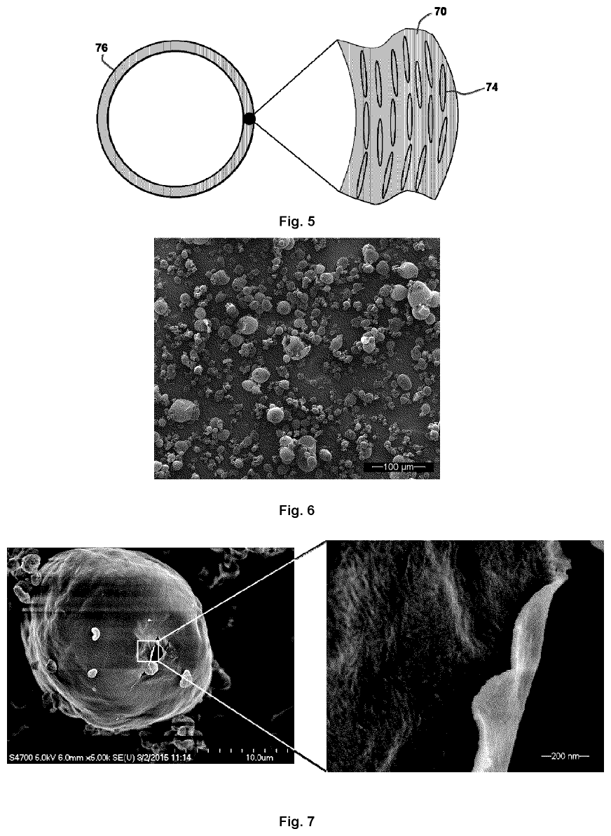

When a CNC suspension is spray dried, the solvent evaporates quickly and the spherical shape collapses owing to the capillary force from the solvent. The morphology of such particles is shown in FIG. 4. However, when a polymer 70 is incorporated in the CNC suspension, a layer of CNC-polymer composite is formed as the shell of the spray-dried microsphere. The CNCs 74 are uniformly distributed in the polymer matrix to form a hierarchical composite layer, and the spherical shape of the droplets 76 is maintained. A schematic depiction of such a microsphere is shown in FIG. 5, illustration of the morphology of actual spray-dried hollow polymer microspheres is presented in FIG. 6.

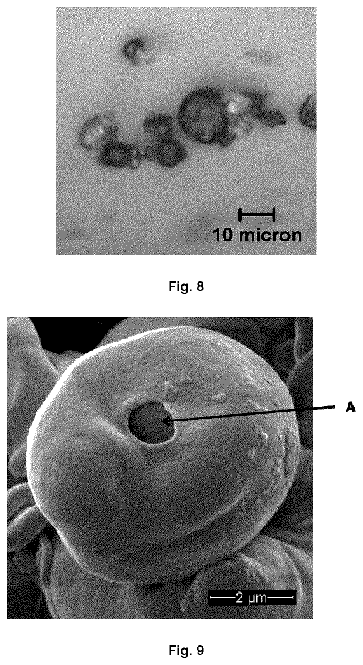

FIG. 7 illustrates the structural formation of a single polymer microsphere, along with the enlarged view of a carefully fractured shell. The composite layer and hierarchical CNC structure in the composite are clearly indicated. When a CNC-stabilized Pickering emulsion is spray dried, the CNC-stabilized oil droplets are directly exposed to hot air after atomization, and a similar composite layer is formed on the oil droplet surfaces. Filled polymer microspheres are thus obtained. FIG. 8 shows an optical microscope image of the morphology of core-shell microspheres, and FIG. 9 clearly depicts the filled content A in these microspheres.

### Example I

### Preparation of CNC-Based Polymer Microspheres

CNCs were produced from bleached softwood pulp by sulfuric acid hydrolysis and used as an aqueous suspension. Two PVA samples with 99% degree of hydrolysis were tested and their molecular weights are listed in Table 1. PVA was directly dissolved in the CNC suspension using magnetic stirring at 80° C. The concentration of CNC was fixed at 2 wt. % and the quantity of PVA was varied to control the ratio of CNC to PVA. Table 2 provides the various recipes.

TABLE 1
Molecular weight of PVA samples tested in the examples

| | Mₙ | M_{w} |
|---|---|---|
| PVA-1 | 50,000 | 94,000 |
| PVA-2 | 67,000 | 132,000 |

TABLE 2
CNCs and PVA combinations spray dried

| | [CNC] | [PVA-1] | [PVA-2] | |
|---|---|---|---|---|
| Recipe # | (wt. %) | (wt. %) | (wt. %) | CNC/PVA |
| 1 | 2 | — | 4 | 1:2 |
| 2 | 2 | — | 2 | 1:1 |
| 3 | 2 | 4 | — | 1:2 |
| 4 | 2 | 2 | — | 1:2 |
| 5 | 2 | 1 | — | 1:0.5 |
| 6 | 2 | 0.3 | — | 1:0.15 |

To produce core-shell, or polymer-filled, microspheres, a CNC-stabilized oil-in-water emulsion was prepared first. In this case, PVA was dissolved in the CNC aqueous suspension directly. The concentration was 2 wt. % for both PVA and CNC. A light mineral oil was then added in the suspension and the oil content was 10 vol. % based on the total volume of the mixture. A Pickering emulsion was formed via high-speed (10,000 rpm) homogenization of the mixture. This emulsion was then spray dried directly.

Hollow microspheres were obtained by spray-drying PVA-grafted CNCs at a concentration of 3 wt. %.

While the present disclosure has been described in connection with specific embodiments thereof, it will be understood that it is capable of further modifications and this application is intended to cover any variations, uses, or adaptations, including such departures from the present disclosure as come within known or customary practice within the art and as may be applied to the essential features hereinbefore set forth, and as follows in the scope of the appended claims.

1. A microspherical structure comprising:
an external shell of structured spray-dried cellulose nanocrystals (CNCs) and at least one polymer, the CNCs are on the surface and polymer on the inside on the inside of the microspherical structure;
and a core.

2. The microspherical structure of claim 1, wherein the polymer is a homopolymer or a copolymer.

3. The microspherical structure of claim 1, wherein the polymer is polyvinyl alcohol (PVA), polyacrylamide, polyethylene oxide, polyethyleneimines, polyamines, quaternary ammonium polymers, carboxymethylated polymers, polyvinylpyrrolidone and copolymers, polyacrylic acid and copolymers, or a mixture thereof.

4. The microspherical structure of claim 1, wherein the CNCs surfaces are functionalized.

5. The microspherical structure of claim 4, wherein the CNCs surfaces are functionalized by pH changing, grafting of a small molecule, or absorption of a small molecule.

6. The microspherical structure of claim 5, wherein the CNCs surfaces are grafted with polyvinyl alchohol (PVA), polyethylene oxide, polyethylene glycol, polymethylmethacrylate, polyethylhexylmethacrylate, or other polymers whose monomers have similar water solubility as CNCs.

7. The microspherical structure of claim 1, wherein the polymer is attached to the CNCs surfaces covalently.

8. The microspherical structure of claim 1, wherein the core comprises an immiscible medium.

9. The microspherical structure of claim 8, wherein the immiscible medium is an oil, solvent or solution containing functional ingredients.

10. The microspherical structure of claim 1, wherein the core is hollow.

11. The microspherical structure of claim 1, comprising from 0.1 to 10 wt. % of CNCs.

12. The microspherical structure of claim 1, wherein the CNCs are from wood pulp, cotton, grass, wheat straw or tunicate.

13. A method of producing the microspherical structure of claim 1 comprising the steps of:
a) suspending cellulose nanocrystals (CNCs) in a solvent forming a suspension of CNCs;
b) mixing the suspension of CNCs and a polymer forming a mixture of CNCs and polymer;
c) spraying said mixture of CNCs and polymer through an atomizer and into a drying chamber forming droplets; and
d) evaporating the solvent from the droplets forming the microspherical structure.

14. The microspherical structure of claim 1, wherein the CNCr are suspended in a solvent is consisting of water, dimethyl sulfoxide (DMSO), N-methylpyrrolidone (NMP), dimethyl acetamide (DMA), N,N-dimethylformamide (DMF), propylene carbonate, acetonitrile, pyridine, methanol, acetone, 1,4-dioxane, butanone, ethyl acetate, tetrahydrofuran (THF), toluene, or xylene.

15. (canceled)

16. The microspherical structure of claim 14, wherein the polymer is first dissolved before being mixed with the suspension of CNCs.

17. The microspherical structure of claim 16, further comprising an immiscible medium which forms a Pickering emulsion with the CNCs and polymer.

18. The microspherical structure of claim 17, wherein the immiscible medium is an oil, a solvent or solution containing functional ingredients.

19. The microspherical structure of claim 17, wherein the Pickering emulsion is formed by high shear mixing.

20-26. (canceled)

27. The method of claim 13, wherein the solvent is evaporated by the addition of hot air in the drying chamber at a temperature of 100 to 200° C.
